(19) United States
(12) Patent Application Publication
(10) Pub. No.: US 2016/0185017 A1
(43) Pub. Date: Jun. 30, 2016

(54) Method for Manufacturing Heterogeneous Composite Foaming Layer Product in a Recycling Manner

(71) Applicant: SIMPLE TEK CORP., Huatan Township (TW)

(72) Inventor: Chen-I Kao, Huatan Township (TW)

(21) Appl. No.: 14/973,843

(22) Filed: Dec. 18, 2015

(30) Foreign Application Priority Data
Dec. 26, 2014 (TW) 103145613

(51) Int. Cl. B29C 43/20; B29C 59/02

(52) U.S. Cl. CPC B29C 43/206; B29C 59/02; B29K 2105/04

(57) ABSTRACT

A method includes preparing a primary staple from recyclable wasted materials, performing pulverizing and stirring operations to form stocks, adding a resilient material and a chemical additive and performing pressing, kneading, mulling and mixing operations, thereby forming a first foam material and a second foam material, applying a pressure on the first foam material and the second foam material to present a sheet state, pressing a net-shaped medium layer between the first foam material and the second foam material under a high temperature condition, such that the first foam material, the medium layer and the second foam material are mixed, foamed and combined together, and releasing the pressure after a determined period of time to obtain a heterogeneous composite foaming layer product including the first foam material, the medium layer and the second foam material.

### BACKGROUND OF THE INVENTION

1. Field of the Invention

The present invention relates to a method for manufacturing a foaming product and, more particularly, to a method for manufacturing a heterogeneous composite foaming layer product.

2. Description of the Related Art

A first conventional method for making a rubber (including natural or synthetic rubber) foam product is a successive extruding method which comprises milling a rubber staple, then extruding the rubber staple by an extruding machine to form a rubber sheet, and then delivering the rubber sheet into a vulcanization molding machine so that the rubber sheet is vulcanized and foamed to form a rubber foam product. A second conventional method for making a rubber foam product is a hot press molding method which comprises using a press die to heat and press a rubber staple so as to form a rubber foam product. A decorative item is bonded onto the surface of the rubber foam product to enhance the aesthetic quality of the rubber foam product so as to attract the consumer. The decorative item is preferably a heterogeneous foam material or plastic skin. The decorative item is bonded onto the surface of the rubber foam product by a gel or bonding agent. However, using the gel or bonding agent will pollute the air and water to cause an environmental problem. In addition, the amount of the gel or bonding agent is not controlled easily and precisely, thereby affecting the heterogeneous combination of the decorative item and the rubber foam product.

### BRIEF SUMMARY OF THE INVENTION

The primary objective of the present invention is to provide a method for manufacturing a heterogeneous composite foaming layer product in a recycling manner.

In accordance with the present invention, there is provided a method for manufacturing a heterogeneous composite foaming layer product, comprising a step a) of preparing a staple: selecting a primary staple from any one or more than two of different recyclable wasted materials including rubber, plastic or fiber; a step b) of pulverizing: using a pulverizer to pulverize the different recyclable wasted materials to form a plurality of fine particles and rough particles with different sizes; a step c) of stirring: placing the fine particles and the rough particles of the same material in a stirrer to perform a stirring operation at a high speed so as to evenly mix the fine particles and the rough particles, thereby forming stocks; a step d) of mixing: selecting the stocks of different materials, adding a resilient material and a chemical additive into the stocks of different materials, placing the stocks into a kneader to perform a pressing, kneading and mulling operation, and placing the stocks into a mixer to perform a mixing operation, thereby forming a first foam material and a second foam material, wherein the first foam material and the second foam material have different mixture proportions of the stocks, the resilient material and the chemical additive, so that the first foam material and the second foam material present two different resilient foam materials; a step e) of sheeting: applying a determined pressure on the first foam material and the second foam material by a sheeter so that the first foam material and the second foam material present a sheet state; a step f) of pressing: placing the first foam material and the second foam material in a hot press and arranging a honeycomb net-shaped medium layer between the first foam material and the second foam material, so that the first foam material, the medium layer and the second foam material laminate each other, wherein the medium layer is selected from a bridging agent that is made of a recyclable material and has a coherence or bonding effect; a step g) of hot press foaming: pressing the first foam material, the medium layer and the second foam material in the hot press under a high temperature condition to perform a chemical bridging treatment, so that when the medium layer is heated and fused, the medium layer releases a determined number of bonding molecules by using the net-shaped state of the medium layer, such that the first foam material, the medium layer and the second foam material are mixed, foamed and combined together; and a step h) of releasing pressure: releasing the pressure applied on the first foam material and the second foam material after a determined period of time to obtain a heterogeneous composite foaming layer product including the first foam material, the medium layer and the second foam material.

According to the primary advantage of the present invention, the method uses recycled wasted staples to manufacture a heterogeneous composite foaming layer product so as to recycle and reuse the wasted staples and achieve an environmental protection purpose.

According to another advantage of the present invention, all of the steps, except the first step of preparing a staple, of the method are performed automatically, so that the heterogeneous composite foaming layer product is fabricated easily and quickly in a precise and stable manner.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a flow chart of a method for manufacturing a heterogeneous composite foaming layer product in accordance with the preferred embodiment of the present invention.

FIG. 2 is a flow chart showing details of the steps of the method as shown in FIG. 1.

FIG. 3 is a perspective view of a heterogeneous composite foaming layer product in accordance with the preferred embodiment of the present invention.

FIG. 4 is an exploded perspective view of the heterogeneous composite foaming layer product as shown in FIG. 3.

### DETAILED DESCRIPTION OF THE INVENTION

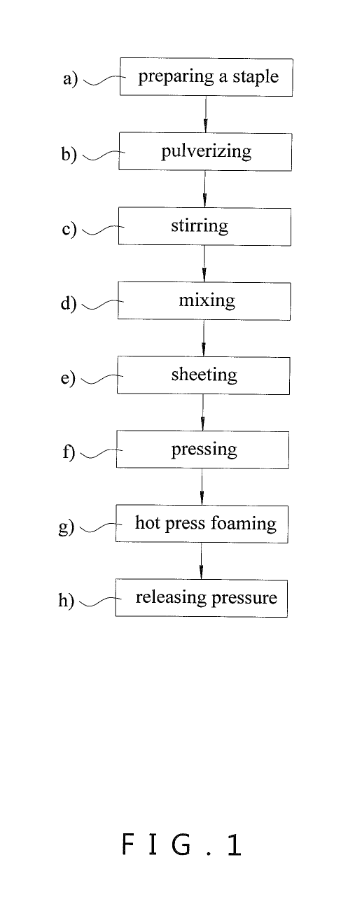

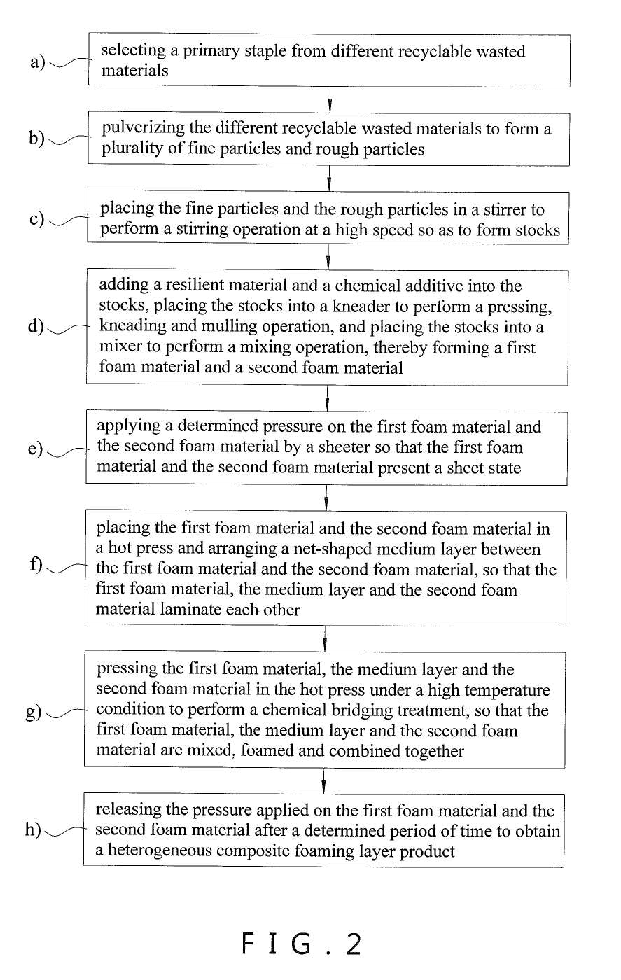

Referring to the drawings and initially to FIGS. 1 and 2, a method for manufacturing a heterogeneous composite foaming layer product in accordance with the present invention comprises a step a) of preparing a staple: selecting a primary staple from any one or more than two of different recyclable wasted materials including rubber, plastic or fiber; a step b) of pulverizing: using a pulverizer to pulverize the different recyclable wasted materials to form a plurality of fine particles and rough particles with different sizes; a step c) of stirring: placing the fine particles and the rough particles of the same material in a stirrer to perform a stirring operation at a high speed so as to evenly mix the fine particles and the rough particles, thereby forming stocks; a step d) of mixing: selecting the stocks of different materials, adding a resilient material and a chemical additive into the stocks of different materials, placing the stocks into a kneader to perform a pressing, kneading and mulling operation, and placing the stocks into a mixer to perform a mixing operation, thereby forming a first foam material and a second foam material, wherein the first foam material and the second foam material have different mixture proportions of the stocks, the resilient material and the chemical additive, so that the first foam material and the second foam material present two different resilient foam materials; a step e) of sheeting: applying a determined pressure on the first foam material and the second foam material by a sheeter so that the first foam material and the second foam material present a sheet state; a step f) of pressing: placing the first foam material and the second foam material in a hot press and arranging a honeycomb net-shaped medium layer between the first foam material and the second foam material, so that the first foam material, the medium layer and the second foam material laminate each other, wherein the medium layer is selected from a bridging agent that is made of a recyclable material and has a coherence or bonding effect; a step g) of hot press foaming: pressing the first foam material, the medium layer and the second foam material in the hot press under a high temperature condition to perform a chemical bridging treatment, so that when the medium layer is heated and fused, the medium layer releases a determined number of bonding molecules by using the net-shaped state of the medium layer, such that the first foam material, the medium layer and the second foam material are mixed, foamed and combined together; and a step h) of releasing pressure: releasing the pressure applied on the first foam material and the second foam material after a determined period of time to obtain a heterogeneous composite foaming layer product including the first foam material, the medium layer and the second foam material.

In the preferred embodiment of the present invention, the step d) further includes selecting the stocks of the same material, and adding the resilient material and the chemical additive into the stocks of the same material, to perform the stirring operation at a high speed so as to achieve an evenly pressing, mixing and mulling effect, thereby forming the first foam material and the second foam material.

In addition, when the stocks of the same material are selected, the first foam material and the second foam material have different mixture proportions of the stocks, the resilient material and the chemical additive, so that the first foam material and the second foam material present two different resilient foam materials.

In the preferred embodiment of the present invention, the step d) further includes performing a sterilizing process to sterilize the stocks of the first foam material and the second foam material by a sterilizer.

In the step d), the resilient material is a natural rubber, and the chemical additive is selected from a foaming agent, an accelerant, a resin softener or a hardener.

In addition, the first foam material and the second foam material are added with different colors respectively.

In the step f), the medium layer is selected from a vulcanizer that is made of a recyclable material and has a coherence or bonding effect.

Alternatively, in the step f), the medium layer is selected from bonding agent which is a mixture of a bridging agent and a vulcanizer, with a mixing ratio of 1:1.

In addition, the medium layer presents a solid phase. Preferably, the medium layer is added with a color the same as that of any one of the first foam material or the second foam material.

In the step g), after the first foam material, the medium layer and the second foam material are mixed, foamed and combined together, the first foam material and the second foam material have a temperature ranged between 25° C. and 50° C., and the medium layer has a temperature ranged between 50° C. and 60° C.

In addition, the medium layer presents a solid phase so that the medium layer has a chemical reaction during the foaming process to produce the bonding molecules at a gas phase so as to stick the first foam material and the second foam material together without needing a gel or adhesive to achieve an environmental protection purpose.

In the preferred embodiment of the present invention, the number of the foam materials of the heterogeneous composite foaming layer product is increased according to a requirement of the product.

In conclusion, the method for manufacturing a heterogeneous composite foaming layer product in accordance with the present invention is described as follows. First of all, a primary staple is selected from any one or more than two of different recyclable wasted materials including rubber, plastic or fiber. Then, the different recyclable wasted materials are placed into a pulverizer to perform a pulverizing operation to form a plurality of particles. Then, the particles are placed into a stirrer to perform a stirring operation at a high speed so as to achieve an evenly mixing effect, thereby forming stocks. Then, the stocks of different materials are added with a resilient material and a chemical additive, are placed into a kneader to perform a pressing, kneading and mulling operation, and are placed into a mixer to perform a mixing operation, thereby forming a first foam material and a second foam material, wherein the first foam material and the second foam material have different mixture proportions of the stocks, the resilient material and the chemical additive, so that the first foam material and the second foam material present two different resilient foam materials. Then, a sheeter applies a determined pressure on the first foam material and the second foam material so that the first foam material and the second foam material present a sheet state. Then, the first foam material and the second foam material are placed into a hot press, and a honeycomb net-shaped medium layer is arranged between the first foam material and the second foam material, so that the first foam material, the medium layer and the second foam material laminate each other. Then, the first foam material, the medium layer and the second foam material in the hot press are pressed under a high temperature condition to perform a chemical bridging treatment, so that when the medium layer is heated and fused, the medium layer releases a determined number of bonding molecules by using the net-shaped state of the medium layer, such that the first foam material, the medium layer and the second foam material are mixed, foamed and combined together. After the first foam material, the medium layer and the second foam material are mixed, foamed and combined together, the first foam material and the second foam material have a temperature ranged between 25° C. and 50° C., and the medium layer has a temperature ranged between 50° C. and 60° C. Finally, the pressure applied on the first foam material and the second foam material is released after a determined period of time to obtain a heterogeneous composite foaming layer product including the first foam material, the medium layer and the second foam material. Thus, the method in accordance with the present invention selects recycled wasted staples to manufacture a heterogeneous composite foaming layer product.

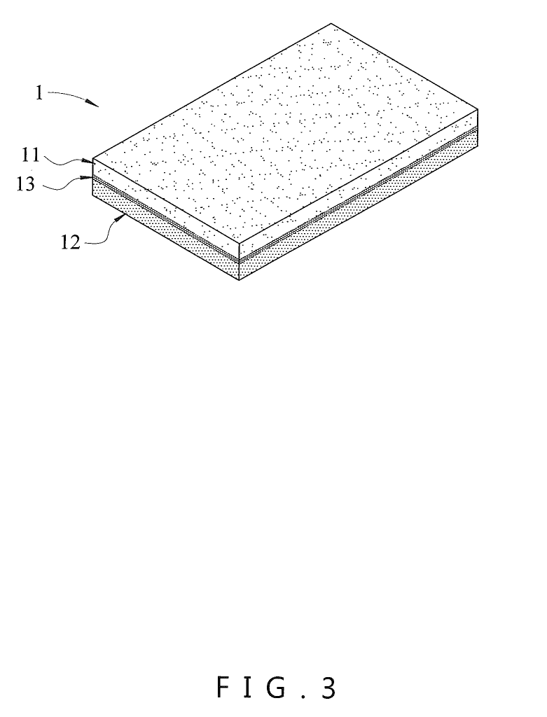

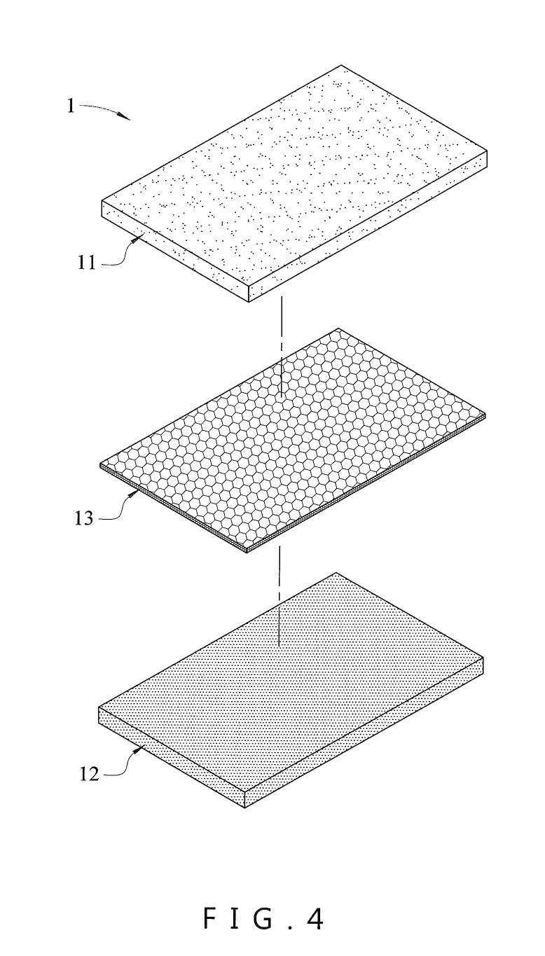

Referring to FIGS. 3 and 4 with reference to FIGS. 1 and 2, a heterogeneous composite foaming layer product 1 in accordance with the preferred embodiment of the present invention comprises a first foam material 11, a medium layer 13, and a second foam material 12. The medium layer 13 is sandwiched between the first foam material 11 and the second foam material 12.

Accordingly, the method uses recycled wasted staples to manufacture a heterogeneous composite foaming layer product so as to recycle and reuse the wasted staples and achieve an environmental protection purpose. In addition, all of the steps, except the first step of preparing a staple, of the method are performed automatically, so that the heterogeneous composite foaming layer product is fabricated easily and quickly in a precise and stable manner.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for manufacturing a heterogeneous composite foaming layer product, comprising:
a step a) of preparing a staple: selecting a primary staple from any one or more than two of different recyclable wasted materials including rubber, plastic or fiber;
a step b) of pulverizing: using a pulverizer to pulverize the different recyclable wasted materials to form a plurality of fine particles and rough particles with different sizes;
a step c) of stirring: placing the fine particles and the rough particles of the same material in a stirrer to perform a stirring operation at a high speed so as to evenly mix the fine particles and the rough particles, thereby forming stocks;
a step d) of mixing: selecting the stocks of different materials, adding a resilient material and a chemical additive into the stocks of different materials, placing the stocks into a kneader to perform a pressing, kneading and mulling operation, and placing the stocks into a mixer to perform a mixing operation, thereby forming a first foam material and a second foam material, wherein the first foam material and the second foam material have different mixture proportions of the stocks, the resilient material and the chemical additive, so that the first foam material and the second foam material present two different resilient foam materials;
a step e) of sheeting: applying a determined pressure on the first foam material and the second foam material by a sheeter so that the first foam material and the second foam material present a sheet state;
a step f) of pressing: placing the first foam material and the second foam material in a hot press and arranging a honeycomb net-shaped medium layer between the first foam material and the second foam material, so that the first foam material, the medium layer and the second foam material laminate each other, wherein the medium layer is selected from a bridging agent that is made of a recyclable material and has a coherence or bonding effect;
a step g) of hot press foaming: pressing the first foam material, the medium layer and the second foam material in the hot press under a high temperature condition to perform a chemical bridging treatment, so that when the medium layer is heated and fused, the medium layer releases a determined number of bonding molecules by using the net-shaped state of the medium layer, such that the first foam material, the medium layer and the second foam material are mixed, foamed and combined together; and
a step h) of releasing pressure: releasing the pressure applied on the first foam material and the second foam material after a determined period of time to obtain a heterogeneous composite foaming layer product including the first foam material, the medium layer and the second foam material.

2. The method for manufacturing a heterogeneous composite foaming layer product of claim 1, wherein the step d) further includes selecting the stocks of the same material, and adding the resilient material and the chemical additive into the stocks of the same material, to perform the stirring operation at a high speed so as to achieve an evenly pressing, mixing and mulling effect, thereby forming the first foam material and the second foam material.

3. The method for manufacturing a heterogeneous composite foaming layer product of claim 2, wherein when the stocks of the same material are selected, the first foam material and the second foam material have different mixture proportions of the stocks, the resilient material and the chemical additive, so that the first foam material and the second foam material present two different resilient foam materials.

4. The method for manufacturing a heterogeneous composite foaming layer product of claim 1, wherein the step d) further includes performing a sterilizing process to sterilize the stocks of the first foam material and the second foam material by a sterilizer.

5. The method for manufacturing a heterogeneous composite foaming layer product of claim 1, wherein the resilient material is a natural rubber, and the chemical additive is selected from a foaming agent, an accelerant, a resin softener or a hardener.

6. The method for manufacturing a heterogeneous composite foaming layer product of claim 1, wherein in the step f), the medium layer is selected from a vulcanizer that is made of a recyclable material and has a coherence or bonding effect.

7. The method for manufacturing a heterogeneous composite foaming layer product of claim 1, wherein in the step f), the medium layer is selected from bonding agent which is a mixture of a bridging agent and a vulcanizer, with a mixing ratio of 1:1.

8. The method for manufacturing a heterogeneous composite foaming layer product of claim 1, wherein after the first foam material, the medium layer and the second foam material are mixed, foamed and combined together, the first foam material and the second foam material have a temperature ranged between 25° C. and 50° C., and the medium layer has a temperature ranged between 50° C. and 60° C.

9. The method for manufacturing a heterogeneous composite foaming layer product of claim 1, wherein the number of the foam materials of the heterogeneous composite foaming layer product is increased according to a requirement of the product.
